(19) United States
(12) Patent Application Publication
(10) Pub. No.: US 2025/0286214 A1
(43) Pub. Date: Sep. 11, 2025

(54) SECONDARY BATTERY AND ELECTRONIC DEVICE

(71) Applicant: Ningde Amperex Technology Limited, Ningde (CN)

(72) Inventor: Meina YAO, Ningde (CN)

(73) Assignee: Ningde Amperex Technology Limited, Ningde (CN)

(21) Appl. No.: 19/074,451

(22) Filed: Mar. 10, 2025

(30) Foreign Application Priority Data
Mar. 11, 2024 (CN) 202410274988.4

(51) Int. Cl. H01M 50/426; H01M 10/0587; H01M 50/434; H01M 50/44; H01M 50/443; H01M 50/451; H01M 50/489

(52) U.S. Cl. CPC H01M 50/426; H01M 10/0587; H01M 50/434; H01M 50/44; H01M 50/443; H01M 50/451; H01M 50/489

(57) ABSTRACT

An electrode assembly includes a positive electrode plate, a negative electrode plate, a first separator, and a second separator. The first separator includes a first base film, a first adhesive layer, and a first ceramic coating. The first base film is a nonwoven fabric film. A first binder includes at least one of polyvinylidene fluoride or poly(vinylidene fluoride-co-hexafluoropropylene). The first ceramic coating includes first ceramic particles. The first ceramic particles include at least one of aluminum oxide, zirconium dioxide, titanium dioxide, or silicon dioxide. The second separator includes a second base film, a second adhesive layer, and a second ceramic coating. The second base film is a polymeric microporous film. A second binder includes at least one of polyimide, polyvinyl alcohol, or sodium carboxymethyl cellulose. The second ceramic coating includes second ceramic particles. The second ceramic particles include boehmite.

### CROSS-REFERENCE TO RELATED APPLICATION

This application claims priority to Chinese Patent Application No. 202410274988.4 filed on Mar. 11, 2024, the entire content of which is incorporated herein by reference.

### TECHNICAL FIELD

This application relates to the field of electrochemical technology, and in particular, to a secondary battery and an electronic device.

### BACKGROUND

Compared with other types of batteries such as lead-acid batteries, a lithium-ion battery exhibits the advantages such as a high energy density, a long cycle life, a low self-discharge rate, and environmental protection and no pollution, and has been widely used in the fields such as aviation, aerospace, marine navigation, and electric vehicles. The performance of a separator in a lithium-ion battery decides an interface structure, an internal resistance, and the like of the lithium-ion battery, and directly affects the capacity, cycle performance, and safety performance of the lithium-ion battery. Excellent performance of the separator plays an important role in improving the overall performance of the battery.

The separator generally includes a base film, a ceramic coating, and an adhesive layer. Each layer serves a distinct function, and each layer is made of a different material. Currently, typical base films include a polyolefin porous film (a microporous film) and a nonwoven fabric film. Typical ceramic coatings include aluminum oxide and boehmite (γ-AlOOH). Typical adhesive layers include polyvinylidene fluoride (PVDF), poly(vinylidene fluoride-co-hexafluoropropylene) (PVDF-HFP), polyimide (PI), polyvinyl alcohol (PVA), sodium carboxymethyl cellulose (CMC-Na), or the like. How to select a suitable separator to improve the electrochemical performance and high-temperature performance of a secondary battery without losing the energy density of the secondary battery has become a pressing challenge currently.

### SUMMARY

An objective of this application is to provide a secondary battery and an electronic device to increase adhesion between each separator and a positive electrode plate and/or a negative electrode plate, and therefore, improve the high-temperature thermal abuse performance of the secondary battery and prolong the cycle life of the secondary battery while achieving a desirable energy density of the secondary battery.

It is hereby noted that in the description hereof, this application is construed by using a lithium-ion battery as an example of the secondary battery, but the secondary battery of this application is not limited to the lithium-ion battery. Specific technical solutions are as follows:

A first aspect of this application provides a secondary battery. The secondary battery includes an electrode assembly. The electrode assembly is a jelly-roll structure. The electrode assembly includes a positive electrode plate, a negative electrode plate, a first separator, and a second separator. The first separator includes a first base film, a first adhesive layer, and a first ceramic coating. The first ceramic coating is located between the first base film and the first adhesive layer. The first base film is a nonwoven fabric film. The first adhesive layer includes a first binder. The first binder includes at least one of polyvinylidene fluoride or poly(vinylidene fluoride-co-hexafluoropropylene). The first ceramic coating includes first ceramic particles. The first ceramic particles include at least one of aluminum oxide, zirconium dioxide, titanium dioxide, or silicon dioxide. The second separator includes a second base film, a second adhesive layer, and a second ceramic coating. The second ceramic coating is located between the second base film and the second adhesive layer. The second base film is a polymeric microporous film. The second adhesive layer includes a second binder. The second binder includes at least one of polyimide, polyvinyl alcohol, or sodium carboxymethyl cellulose. The second ceramic coating includes second ceramic particles. The second ceramic particles include boehmite. This application uses the first base film as a nonwoven fabric, with a relatively high glass transition temperature and good thermal stability. With the rise of the internal temperature of the secondary battery during charge and discharge, the first base film maintains a relatively high porosity while possessing relatively high mechanical strength. This enables smooth flow of an electrolyte solution and improves the transmission rate of lithium ions. The stable pore structure of the first base film can also improve the capabilities of absorbing and retaining the electrolyte solution. However, the thickness of the first base film is relatively large due to the characteristics of the manufacturing process. The first base film used in combination with an oxide ceramic coating makes up for the disadvantage that the heat resistance of the first base film is relatively low, and contributes to relatively high stability of the first separator at high temperature. In addition, the high electrolyte retainability of the first base film and the high electrolyte retainability of the oxide ceramic coating are added up to further improve the cycle performance of the secondary battery. The oxide ceramic coating is of high electrolyte retainability but of relatively low adhesiveness. Therefore, used in combination with the PVDF or PVDF-HFP that is well swellable in the electrolyte solution and that is of high adhesiveness at normal temperature, the oxide ceramic coating can implement relatively strong adhesion between the first separator and the electrode plate, and endow the secondary battery with good cycle performance. The second base film is a polymeric microporous film with a relatively low glass transition temperature. A relatively thin second base film can be prepared by a wet process or a dry process by means of uniaxial stretching or biaxial stretching, so as to compensate for the energy density loss caused by the relatively thick first base film. The second base film coordinates with the second ceramic coating (boehmite) of a high heat resistance and a high puncture resistance, and the second ceramic coating can more effectively prevent the second base film from shrinking or closing pores at high temperature, thereby endowing the second separator with high safety. The boehmite ceramic coating is of high adhesiveness and a high heat resistance, and boehmite plays a role in promoting the swelling of the binder in the electrolyte solution. Therefore, the boehmite ceramic coating used in combination with a high-melting PI, PVA, or CMC-Na adhesive layer can significantly improve the adhesion between the second separator and the electrode plate at normal temperature while improving the high-temperature performance of the second separator. The first separator and the second separator are of relatively high mechanical strength, and can slow down the shrinkage of the first separator and the second separator during cycling of the secondary battery in a high-temperature environment, and reduce the probability of short circuiting caused by contact between the positive electrode plate and the negative electrode plate due to the shrinkage of the separator during charge and discharge of the secondary battery, thereby improving the high-temperature thermal abuse performance of the secondary battery. In addition, the first separator and the second separator are of high wettability and electrolyte retainability, thereby improving the cycle performance of the secondary battery. Therefore, the secondary battery of this application uses a first separator and a second separator of different types in combination, and controls the types of the first base film, the first inorganic particles, and the first binder in the first separator as well as the types of the second base film, the second inorganic particles, and the second binder in the second separator to fall within the ranges specified herein. In this way, the separators are of high adhesion to the positive electrode plate and/or negative electrode plate, and the secondary battery achieves a desirable level of energy density, expansion resistance, cycle performance, and high-temperature thermal abuse performance simultaneously.

In an embodiment of this application, the negative electrode plate is located between the first separator and the second separator. The negative electrode plate includes a negative current collector as well as a first negative electrode material layer and a second negative electrode material layer located on two sides of the negative current collector respectively. Along a winding direction of the electrode assembly, a length of the first negative electrode material layer is greater than a length of the second negative electrode material layer. The first separator is located on the same side as the first negative electrode material layer of the negative electrode plate. The second separator is located on the same side as the second negative electrode material layer of the negative electrode plate. The above arrangement makes it convenient for the first separator to store more electrolyte solution. When the first separator is located on the same side as the first negative electrode material layer of the negative electrode plate, the above arrangement reduces the risk of lithium plating at the interface between the electrolyte solution and the negative electrode plate caused by electrolyte flow discontinuity at the later stage of cycling of the secondary battery. The above arrangement improves the high-temperature thermal abuse performance of the secondary battery and prolongs the cycle life of the secondary battery while achieving a desirable energy density.

In an embodiment of this application, the second separator is located between the positive electrode plate and the negative electrode plate. The first ceramic coating is located on both sides of the first base film. The first ceramic particles include aluminum oxide. The second ceramic coating is located on just one side of the second base film, the side facing away from the negative electrode plate. Through the above arrangement, the second ceramic coating is disposed on one side of the second base film, the side facing away from the negative electrode plate. In other words, the second ceramic coating faces the positive electrode plate. The boehmite in the second ceramic particles endows the second separator with a higher heat resistance and a higher puncture resistance. Therefore, disposing the second separator between the positive electrode plate and the negative electrode plate can more effectively prevent short circuiting between the positive electrode and the negative electrode when the secondary battery works under conditions such as high temperature and puncture, thereby reducing the probability of the large-sized or pointy positive active material particles piercing the second separator, protecting the second base film more securely, and in turn, improving the safety performance of the secondary battery. In addition, the second ceramic coating is disposed on just one side of the second base film, thereby reducing the thickness of the second separator, reducing the thickness of the secondary battery, and in turn, increasing the energy density of the secondary battery.

In an embodiment of this application, an average particle diameter of the first ceramic particles is 0.2 μm to 1.2 μm, and an average particle diameter of the second ceramic particles is 0.1 μm to 1.0 μm. The average particle diameter of the first ceramic particles and the average particle diameter of the second ceramic particles are controlled to fall within the above ranges, so that the first ceramic particles and the second ceramic particles possess a relatively large specific surface area, thereby endowing the secondary battery with a relatively long cycle life and superior high-temperature thermal abuse performance in addition to a desirable energy density.

In an embodiment of this application, a thickness of the first ceramic coating is 0.5 μm to 1.5 μm, and a thickness of the second ceramic coating is 0.3 μm to 1.5 μm. Controlling the thicknesses of the first ceramic coating and the second ceramic coating to fall within the above ranges contributes to a relatively small thickness of the first separator and the second separator and a relatively small size of the secondary battery, improves the thermal stability and strength of the first separator and the second separator, improves the high-temperature thermal abuse performance of the secondary battery, and at the same time, improves the electrolyte retainability and wettability of the first separator and the second separator. In this way, the secondary battery achieves a relatively long cycle life and superior high-temperature thermal abuse performance in addition to a desirable energy density.

In an embodiment of this application, a thickness of the first base film is 10 μm to 15 μm, and a thickness of the second base film is 3 μm to 9 μm. Controlling the thickness of the first base film and the thickness of the second base film to fall within the above ranges contributes to a relatively small thickness of the first separator and the second separator, and therefore, contributes to a relatively small size of the secondary battery, thereby reducing the risk that the lithium dendrites generated during the cycling of the secondary battery pierce the second base film and cause a short circuit in the secondary battery, and endowing the first base film and the second base film with high mechanical strength. The above arrangement improves the high-temperature thermal abuse performance of the secondary battery and prolongs the cycle life of the secondary battery while achieving a desirable energy density.

In an embodiment of this application, an average pore diameter of the first base film is 80 nm to 700 nm, and an average pore diameter of the second base film is 50 nm to 200 nm. Controlling the average pore diameter of the first base film and the average pore diameter of the second base film to fall within the above ranges facilitates the transmission of lithium ions and improves the cycle performance of the secondary battery. Therefore, the secondary battery achieves good high-temperature thermal abuse performance and a relatively long cycle life in addition to a desirable energy density.

In an embodiment of this application, a material of the first base film includes polyethylene terephthalate, and a material of the second base film includes at least one of polypropylene or polyethylene. When falling within the above ranges, the types of materials of the first base film and the second base film improve the high-temperature thermal abuse performance of the secondary battery and prolong the cycle life of the secondary battery while contributing to a desirable energy density.

In an embodiment of this application, a glass transition temperature of the first base film is 80° C. to 100° C., and a glass transition temperature of the second base film is 25° C. to 50° C. When falling within the above ranges, the glass transition temperature of the first base film and the glass transition temperature of the second base film improve the high-temperature thermal abuse performance of the secondary battery and prolong the cycle life of the secondary battery while achieving a desirable energy density.

A second aspect of this application provides an electronic device. The electronic device includes the secondary battery disclosed in any one of the preceding embodiments. The secondary battery of this application exhibits good high-temperature performance and achieves a relatively long cycle life in addition to a desirable energy density. Therefore, the electronic device of this application achieves a relatively long service life.

Some of the beneficial effects of this application are as follows:

This application provides a secondary battery and an electronic device. The secondary battery includes an electrode assembly. The electrode assembly is a jelly-roll structure. The electrode assembly includes a positive electrode plate, a negative electrode plate, a first separator, and a second separator. The first separator includes a first base film, a first adhesive layer, and a first ceramic coating. The first ceramic coating is located between the first base film and the first adhesive layer. The first base film is a nonwoven fabric film. The first adhesive layer includes a first binder. The first binder includes at least one of polyvinylidene fluoride or poly(vinylidene fluoride-co-hexafluoropropylene). The first ceramic coating includes first ceramic particles. The first ceramic particles include at least one of aluminum oxide, zirconium dioxide, titanium dioxide, or silicon dioxide. The second separator includes a second base film, a second adhesive layer, and a second ceramic coating. The second ceramic coating is located between the second base film and the second adhesive layer. The second base film is a polymeric microporous film. The second adhesive layer includes a second binder. The second binder includes at least one of polyimide, polyvinyl alcohol, or sodium carboxymethyl cellulose. The second ceramic coating includes second ceramic particles. The second ceramic particles include boehmite. The secondary battery of this application uses a first separator and a second separator of different types in combination, and controls the types of the first base film, the first inorganic particles, and the first binder in the first separator as well as the types of the second base film, the second inorganic particles, and the second binder in the second separator to fall within the ranges specified herein. In this way, the separators are of high adhesion to the positive electrode plate and/or negative electrode plate, and the secondary battery achieves a desirable level of energy density, expansion resistance, cycle performance, and high-temperature thermal abuse performance simultaneously.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic structural diagram of an electrode assembly according to an embodiment of this application; and

FIG. 2 is a schematic structural diagram of an electrode assembly according to another embodiment of this application.

List of reference numerals: electrode assembly 100; first separator 10; first base film 11; first adhesive layer 12; first ceramic coating 13; second separator 20; second base film 21; second adhesive layer 22; second ceramic coating 23; negative electrode plate 30; negative current collector 31; first negative electrode material layer 33; second negative electrode material layer 34; positive electrode plate 40; positive current collector 41; positive electrode material layer 42.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in specific embodiments of this application, this application is construed by using a lithium-ion battery as an example of the secondary battery, but the secondary battery of this application is not limited to the lithium-ion battery.

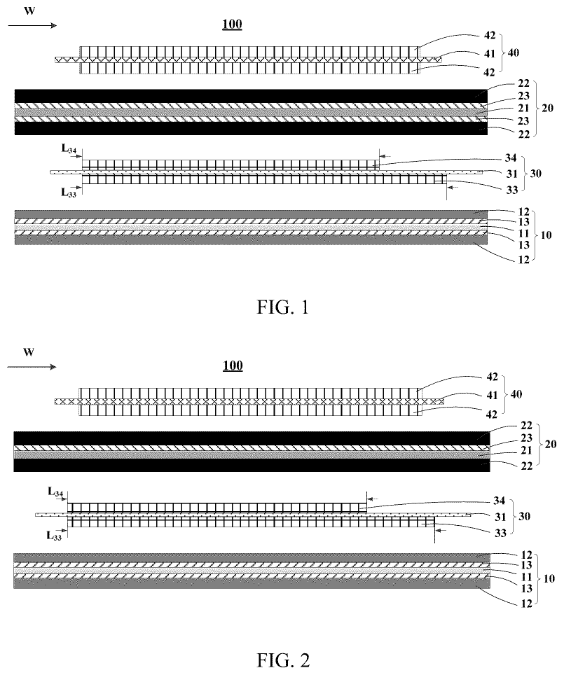

A first aspect of this application provides a secondary battery. As shown in FIG. 1, the secondary battery includes an electrode assembly 100. The electrode assembly 100 is a jelly-roll structure. It is defined that the winding direction of the electrode assembly is a W direction. The electrode assembly 100 includes a first separator 10, a second separator 20, a negative electrode plate 30, and a positive electrode plate 40. The first separator 10 includes a first base film 11, a first adhesive layer 12, and a first ceramic coating 13. The first ceramic coating 13 is located between the first base film 11 and the first adhesive layer 12. The first base film 11 is a nonwoven fabric film. The first adhesive layer 12 includes a first binder. The first binder includes at least one of polyvinylidene fluoride (PVDF) or poly(vinylidene fluoride-co-hexafluoropropylene) (PVDF-HFP). The first ceramic coating 13 includes first ceramic particles. The first ceramic particles include at least one of aluminum oxide (Al₂O₃), zirconium dioxide (ZrO₂), titanium dioxide (TiO₂), or silicon dioxide (SiO₂). The second separator 20 includes a second base film 21, a second adhesive layer 22, and a second ceramic coating 23. The second ceramic coating 23 is located between the second base film 21 and the second adhesive layer 22. The second base film 21 is a polymeric microporous film. The second adhesive layer 22 includes a second binder. The second binder includes at least one of polyimide (PI), polyvinyl alcohol (PVA), or sodium carboxymethyl cellulose (CMC-Na). The second ceramic coating 23 includes second ceramic particles. The second ceramic particles include boehmite (γ-AlOOH).

A typical base film for a separator in an existing secondary battery is a polymeric microporous film. The polymeric microporous film is typically prepared from a material such as polyolefin by a wet process or a dry process by means of uniaxial stretching or biaxial stretching, or by a thermally induced phase separation method. The polymeric microporous film is inexpensive and of relatively high mechanical strength and chemical stability, and is relatively resistant to organic solvents. In addition, the thickness of the polymeric microporous film is typically small. When the polymeric microporous film is applied to a secondary battery, assuming that the size of the secondary battery is constant, the volumetric energy density of the secondary battery is relatively high. However, the glass transition temperature of the polymeric microporous film is relatively low. During charge and discharge of the secondary battery, when the internal temperature of the secondary battery reaches approximately 60° C., due to the intercalation and deintercalation of lithium ions, the positive electrode plate and the negative electrode plate expand and shrink to generate internal stress. The internal stress is transmitted to the polymeric microporous film to squeeze the polymeric microporous film, thereby reducing the porosity gradually. The reduced porosity of the polymeric microporous film makes it difficult to intercalate and deintercalate lithium ions and shortens the cycle life of the secondary battery. In addition, the reduced porosity of the polymeric microporous film makes it difficult to dissipate the heat inside the secondary battery, and results in an excessive temperature rise of the secondary battery, thereby impairing the safety performance of the secondary battery. The nonwoven film is of relatively high capability of storing an electrolyte solution, and the glass transition temperature of the nonwoven film is relatively high, so that the thermal stability of the nonwoven film is relatively high. With the rise of the internal temperature of the secondary battery during charge and discharge, the nonwoven film maintains a relatively high porosity in addition to relatively high mechanical strength, thereby contributing to smooth flow of the electrolyte solution and improving the transmission rate of lithium ions. However, the thickness of the nonwoven fabric film is usually large, and is prone to impair the energy density of the secondary battery.

The ceramic particles in the ceramic coating in an existing separator are typically classed into two types: oxide and boehmite, both exerting a great impact on the performance of secondary batteries. The oxide-containing ceramic coating is highly wettable and highly capable of absorbing and retaining an electrolyte solution, thereby improving the cycle performance of the secondary battery. However, the oxide is of high hardness, causes great wear on a machine, and gives rise high cost of equipment. In addition, the oxide possesses a large specific gravity and is not flame retardant, thereby being adverse to the energy density and safety of the secondary battery. Compared with oxides, boehmite is of low hardness, high heat resistance, low density, and good adhesiveness, and can improve the heat resistance and puncture resistance of the separator and improve the safety performance and energy density of the secondary battery. However, boehmite is not much wettable by an electrolyte solution, and is adverse to electrolyte solution retention and the cycle performance of the secondary battery.

The binders in the adhesive layer of existing separators typically include a low-melting binder (melting at approximately 115° C. to 170° C.) such as polyvinylidene fluoride (PVDF) or poly(vinylidene fluoride-co-hexafluoropropylene) (PVDF-HFP), and a high-melting binder (melting at more than 200° C.) such as polyimide (PI), polyvinyl alcohol (PVA), or sodium carboxymethyl cellulose (CMC-Na). The PVDF or PVDF-HFP exhibit the advantages such as low crystallinity and glass transition temperature, excellent compatibility with an electrolyte solution, and high adhesiveness to an electrode plate. However, due to a low melting point, when an external temperature is close to the melting point of the binder, the binder melts and is unable to effectively adhere to the ceramic coating, and therefore, is unable to further prevent shrinkage of the base film of the separator. The PI, PVA, and CMC-Na can effectively adhere to the ceramic coating at higher temperatures, thereby improving the high-temperature safety and stability of the secondary battery. However, such binders are unable to swell in the electrolyte solution like PVDF and PVDF-HFP, and are of low ionic conductivity. At a relatively low temperature, the adhesive layer containing PI, PVA, or CMC-Na is adverse to the cycle performance of the secondary battery.

This application uses the first base film as a nonwoven fabric, with a relatively high glass transition temperature and good thermal stability. With the rise of the internal temperature of the secondary battery during charge and discharge, the first base film maintains a relatively high porosity while possessing relatively high mechanical strength. This enables smooth flow of an electrolyte solution and improves the transmission rate of lithium ions. The stable pore structure of the first base film can also improve the capabilities of absorbing and retaining the electrolyte solution. However, the thickness of the first base film is relatively large due to the characteristics of the manufacturing process. The first base film used in combination with an oxide ceramic coating makes up for the disadvantage that the heat resistance of the first base film is relatively low, and contributes to relatively high stability of the first separator at high temperature. In addition, the high electrolyte retainability of the first base film and the high electrolyte retainability of the oxide ceramic coating are added up to further improve the cycle performance of the secondary battery. The oxide ceramic coating is of high electrolyte retainability but of relatively low adhesiveness. Therefore, used in combination with the PVDF or PVDF-HFP that is well swellable in the electrolyte solution and that is of high adhesiveness at normal temperature, the oxide ceramic coating can implement relatively strong adhesion between the first separator and the electrode plate, and endow the secondary battery with good cycle performance. The second base film is a polymeric microporous film with a relatively low glass transition temperature. A relatively thin second base film can be prepared by a wet process or a dry process by means of uniaxial stretching or biaxial stretching, so as to compensate for the energy density loss caused by the relatively thick first base film. The second base film coordinates with the second ceramic coating (boehmite) of a high heat resistance and a high puncture resistance, and the second ceramic coating can more effectively prevent the second base film from shrinking or closing pores at high temperature, thereby endowing the second separator with high safety. The boehmite ceramic coating is of high adhesiveness and a high heat resistance, and boehmite plays a role in promoting the swelling of the binder in the electrolyte solution. Therefore, the boehmite ceramic coating used in combination with a high-melting PI, PVA, or CMC-Na adhesive layer can significantly improve the adhesion between the second separator and the electrode plate at normal temperature while improving the high-temperature performance of the second separator. The first separator and the second separator are of relatively high mechanical strength, and can slow down the shrinkage of the first separator and the second separator during cycling of the secondary battery in a high-temperature environment, and reduce the probability of short circuiting caused by contact between the positive electrode plate and the negative electrode plate due to the shrinkage of the separator during charge and discharge of the secondary battery, thereby improving the high-temperature thermal abuse performance of the secondary battery. In addition, the first separator and the second separator are of high wettability and electrolyte retainability, thereby improving the cycle performance of the secondary battery. Therefore, the secondary battery of this application uses a first separator and a second separator of different types in combination, and controls the types of the first base film, the first inorganic particles, and the first binder in the first separator as well as the types of the second base film, the second inorganic particles, and the second binder in the second separator to fall within the ranges specified herein. In this way, the separators are of high adhesion to the positive electrode plate and/or negative electrode plate, and the secondary battery achieves a desirable level of energy density, expansion resistance, cycle performance, and high-temperature thermal abuse performance simultaneously.

In an embodiment of this application, as shown in FIG. 1 and FIG. 2, the negative electrode plate 30 is located between the first separator 10 and the second separator 20. The negative electrode plate 30 includes a negative current collector 31 as well as a first negative electrode material layer 33 and a second negative electrode material layer 34 located on two sides of the negative current collector 31 respectively. Along a winding direction W of the electrode assembly, a length L33 of the first negative electrode material layer 33 is greater than a length L34 of the second negative electrode material layer 34. The first separator 10 is located on the same side as the first negative electrode material layer 33 of the negative electrode plate 30. In other words, the first separator 10 is adjacent to the first negative electrode material layer 33. The second separator 20 is located on the same side as the second negative electrode material layer 34 of the negative electrode plate 30. In other words, the second separator 20 is adjacent to the second negative electrode material layer 34. Through the above arrangement, the average pore diameter of the nonwoven fabric film is relatively large and the average particle diameter of the first ceramic particles, that is, the oxide, is relatively large, thereby contributing to higher wettability of the first separator and higher capabilities of the first separator in absorbing and retaining the electrolyte solution, and making it convenient for the first separator to store more electrolyte solution, and in turn, improving the cycle performance of the secondary battery. When the first separator is located on the same side as the first negative electrode material layer of the negative electrode plate, it is convenient for the A side of the negative electrode plate of the secondary battery to adsorb more electrolyte solution, thereby improving the electrolyte storage performance of the negative electrode plate, facilitating more negative electrode active materials to contact a large amount of electrolyte solution, further improving the cycle performance of the secondary battery, and reducing the risk of lithium plating at the interface between the electrolyte solution and the negative electrode plate caused by electrolyte flow discontinuity at the later stage of cycling of the secondary battery. In addition, the above structure disposed in the secondary battery improves the high-temperature thermal abuse performance of the secondary battery and prolongs the cycle life of the secondary battery while achieving a desirable energy density. In this application, the A side of the negative electrode plate means one side, containing the first negative electrode material layer, of the negative electrode plate, that is, the side with a relatively long negative electrode material layer in the negative electrode plate.

In an embodiment of this application, the negative electrode plate is located between the first separator and the second separator. The negative electrode plate includes a negative current collector as well as a first negative electrode material layer and a second negative electrode material layer located on two sides of the negative current collector respectively. Along a winding direction of the electrode assembly, a length of the first negative electrode material layer between two ends is greater than a length of the second negative electrode material layer between two ends. The first separator is located on the same side as the first negative electrode material layer of the negative electrode plate. The second separator is located on the same side as the second negative electrode material layer of the negative electrode plate. The above structural arrangement reduces the risk of lithium plating at the interface between the electrolyte solution and the negative electrode plate caused by electrolyte flow discontinuity at the later stage of cycling of the secondary battery. In addition, the above structure disposed in the secondary battery improves the high-temperature thermal abuse performance of the secondary battery and prolongs the cycle life of the secondary battery while achieving a desirable energy density.

In an embodiment of this application, as shown in FIG. 2, the second separator 20 is located between the positive electrode plate 40 and the negative electrode plate 30. The first ceramic coating 13 is located on both sides of the first base film 11. The first ceramic particles include aluminum oxide. The second ceramic coating 23 is located on just one side of the second base film 21, the side facing away from the negative electrode plate 30. In other words, the second ceramic coating 23 is disposed on one side of the second base film 21, the side being close to and facing the positive electrode plate 40. No second ceramic coating 23 is disposed on a side, close to the negative electrode plate 30, of the second base film 21. When the positive active material particles in the positive electrode plate are large-sized or pointy, the positive active material particles may squeeze or even pierce the separator between the positive electrode plate and the negative electrode plate in a process of producing or using the secondary battery, thereby causing a short circuit between the positive electrode plate and the negative electrode plate. Through the above arrangement, the second ceramic coating is disposed on one side of the second base film, the side facing away from the negative electrode plate. In other words, the second ceramic coating faces the positive electrode plate. The boehmite in the second ceramic particles endows the second separator with a higher heat resistance and a higher puncture resistance. Therefore, disposing the second separator between the positive electrode plate and the negative electrode plate can more effectively prevent short circuiting between the positive electrode and the negative electrode when the secondary battery works under conditions such as high temperature and puncture, thereby reducing the probability of the large-sized or pointy positive active material particles piercing the second separator, protecting the second base film more securely, and in turn, improving the safety performance of the secondary battery. In addition, the second ceramic coating is disposed on just one side of the second base film, thereby reducing the thickness of the second separator, reducing the thickness of the secondary battery, and in turn, increasing the energy density of the secondary battery. Therefore, the secondary battery is endowed with a relatively long cycle life and superior high-temperature thermal abuse performance in addition to a desirable energy density.

In an embodiment of this application, an average particle diameter D₁ of the first ceramic particles is 0.2 μm to 1.2 μm, and an average particle diameter D₂ of the second ceramic particles is 0.1 μm to 1.0 μm. For example, the average particle diameter D₁ of the first ceramic particles may be 0.2 μm, 0.4 μm, 0.6 μm, 0.8 μm, 1.0 μm, 1.2 μm, or a value falling within a range formed by any two thereof; and the average particle diameter D₂ of the second ceramic particles may be 0.1 μm, 0.2 μm, 0.3 μm, 0.4 μm, 0.5 μm, 0.6 μm, 0.7 μm, 0.8 μm, 0.9 μm, 1.0 μm, or a value falling within a range formed any two thereof. The average particle diameter of the first ceramic particles and the average particle diameter of the second ceramic particles are controlled to fall within the above ranges, so that the first ceramic particles and the second ceramic particles possess a relatively large specific surface area, thereby increasing the electrolyte retention amount of the first separator and the second separator, and in turn, improving the electrolyte retainability and wettability of the first separator and the second separator, and improving the cycle performance of the secondary battery. Therefore, the secondary battery is endowed with a relatively long cycle life and superior high-temperature thermal abuse performance in addition to a desirable energy density. The methods for adjusting and controlling the average particle diameters of the first ceramic particles and the second ceramic particles are not particularly limited herein, as long as the objectives of this application can be achieved. For example, the average particle diameters may be adjusted and controlled by pulverization and sieving.

In an embodiment of this application, the thickness H₁ of the first ceramic coating is 0.5 μm to 1.5 μm, and the thickness H₂ of the second ceramic coating is 0.3 μm to 1.5 μm. For example, the thickness H₁ of the first ceramic coating may be 0.5 μm, 0.8 μm, 1.0 μm, 1.2 μm, 1.4 μm, 1.5 μm, or a value falling within a range formed any two thereof; and the thickness H₂ of the second ceramic coating may be 0.3 μm, 0.5 μm, 0.8 μm, 1.0 μm, 1.2 μm, 1.4 μm, 1.5 μm, or a value falling within a range formed any two thereof. Controlling the thicknesses of the first ceramic coating and the second ceramic coating to fall within the above ranges contributes to a relatively small thickness of the first separator and the second separator and a relatively small size of the secondary battery, improves the thermal stability and strength of the first separator and the second separator, improves the mechanical properties of the separators, reduces the probability of large-area contact between the positive electrode plate and the negative electrode plate caused by the shrinkage of the first separator and/or the second separator during charge and discharge of the secondary battery, and improves the capability of binding the first separator and the second separator, thereby improving the high-temperature thermal abuse performance of the secondary battery. At the same time, the first ceramic coating and the second ceramic coating can absorb a part of the electrolyte solution, thereby improving the electrolyte retention amount of the first separator and the second separator, and in turn, improving the electrolyte retainability and wettability of the first separator and the second separator. In this way, the secondary battery achieves a relatively long cycle life and superior high-temperature thermal abuse performance in addition to a desirable energy density.

In an embodiment of this application, the thickness h₁ of the first base film is 10 μm to 15 μm, and the thickness h₂ of the second base film is 3 μm to 9 μm. For example, the thickness h₁ of the first base film may be 10 μm, 11 μm, 12 μm, 13 μm, 14 μm, 15 μm, or a value falling within a range formed any two thereof; and the thickness h₂ of the second base film may be 3 μm, 5 μm, 6 μm, 7 μm, 8 μm, 9 μm, or a value falling within a range formed any two thereof. Controlling the thickness of the first base film and the thickness of the second base film to fall within the above ranges contributes to a relatively small thickness of the first separator and the second separator, and therefore, contributes to a relatively small size of the secondary battery, thereby reducing the risk that the lithium dendrites generated during the cycling of the secondary battery pierce the second base film and cause a short circuit in the secondary battery, endowing the first base film and the second base film with high mechanical strength, and making the lithium-ion transmission distance moderate during cycling of the secondary battery. The above arrangement improves the high-temperature thermal abuse performance of the secondary battery and prolongs the cycle life of the secondary battery while achieving a desirable energy density. The methods for regulating the thickness h₁ of the first base film and the thickness h₂ of the second base film are not particularly limited herein, as long as the objectives of this application can be achieved. For example, a nonwoven fabric film and a polymeric microporous film of different thicknesses, which are commercially available, may be selected. The thicknesses of the nonwoven fabric film and the polymeric microporous film may be determined with reference to the test method of “Testing the thicknesses of the first ceramic coating, the second ceramic coating, the first base film, and the second base film” described herein. The first base film and the second base film of the desired thickness are selected.

In an embodiment of this application, an average pore diameter d₁ of the first base film is 80 nm to 700 nm, and an average pore diameter d₂ of the second base film is 50 nm to 200 nm. For example, the average pore diameter d₁ of the first base film may be 80 nm, 100 nm, 110 nm, 130 nm, 150 nm, 180 nm, 200 nm, 250 nm, 300 nm, 350 nm, 400 nm, 450 nm, 500 nm, 550 nm, 600 nm, 650 nm, 700 nm, or a value falling within a range formed any two thereof; and the average pore diameter d₂ of the second base film may be 50 nm, 70 nm, 80 nm, 90 nm, 100 nm, 150 nm, 180 nm, 200 nm, or a value falling within a range formed any two thereof. Controlling the average pore diameter of the first base film and the average pore diameter of the second base film to fall within the above ranges facilitates the transmission of lithium ions, and contributes to relatively high kinetic performance of lithium ions during charge-discharge transmission of the secondary battery. At the same time, the above arrangement enables the base films to absorb a relatively large amount of electrolyte solution, and contributes to relatively high wettability of the first separator and the second separator, thereby improving the cycle performance of the secondary battery. Therefore, the secondary battery achieves good high-temperature thermal abuse performance and a relatively long cycle life in addition to a desirable energy density. The methods for regulating the average pore diameter of the first base film and the average pore diameter of the second base film are not particularly limited herein, as long as the objectives of this application can be achieved. For example, a nonwoven fabric film and a polymeric microporous film of different average pore diameters, which are commercially available, may be selected. The average pore diameters of the nonwoven fabric film and the polymeric microporous film may be determined with reference to the test method of “Testing the average pore diameters of the first base film and the second base film” described herein. The first base film and the second base film of the desired average pore diameter are selected.

In an embodiment of this application, a material of the first base film includes polyethylene terephthalate (PET), and a material of the second base film includes at least one of polypropylene (PP) or polyethylene (PE). When the types of materials of the first base film and the second base film fall within the above ranges, the dual-separator structure, that is, the first separator and the second separator, disposed in the secondary battery improves the high-temperature thermal abuse performance of the secondary battery and prolongs the cycle life of the secondary battery while contributing to a desirable energy density. The weight-average molecular weight of the material of the first base film is not particularly limited herein, as long as the objectives of this application can be achieved. For example, the weight-average molecular weight of the material of the first base film is 2×10⁵ to 1.5×10⁶. The weight-average molecular weight of the material of the second base film is not particularly limited herein, as long as the objectives of this application can be achieved. For example, the weight-average molecular weight of the material of the second base film is 2×10⁵ to 1.5×10⁶. The method for preparing the polymeric microporous film is not particularly limited herein, as long as the objectives of this application can be achieved. For example, the polymeric microporous film is prepared from a material falling within the range specified herein by a wet process or a dry process by means of uniaxial stretching or biaxial stretching, or by a thermally induced phase separation method. The method for preparing the nonwoven fabric film is not particularly limited herein, as long as the objectives of this application can be achieved. For example, the nonwoven fabric film may be prepared from a material falling within the range specified herein by at least one of the following methods: meltblowing, spunbonding, wet papermaking, hydroentangling, needlepunching, or hot rolling. In this application, understandably, the material of the nonwoven fabric film is the material of the first base film, and the material of the polymeric microporous film is the material of the second base film. Alternatively, a nonwoven fabric film and a polymeric microporous film of different materials, which are commercially available, are selected, and the first base film and the second base film of desired materials are selected. The materials are not particularly limited herein, as long as the objectives of this application can be achieved.

In an embodiment of this application, the materials of the first base film include at least one of polyimide, polyamide, polysulfone, polyacrylonitrile, polyester, cellulose, polyetheretherketone, polyphenylene sulfide, polyacrylate ester, polyethylene terephthalate (PET), poly(p-benzamide), polyarylethersulfoneketone, aramid fiber, or poly(aromatic sulfone) fiber; and the materials of the second base film include polyolefin. The polymerization monomers of the polyolefin include at least one of ethylene, propylene, 1-butene, 1-pentene, 1-hexene, 1-octene, 4-methyl-1-pentene, cyclobutene, cyclopentene, or cyclohexene. For example, the material of the second base film may include at least one of polyethylene, polypropylene, poly-1-butene, poly-1-pentene, poly-1-hexene, poly-1-octene, poly-4-methyl-1-pentene, polycyclobutene, polycyclopentene, polycyclohexene, or poly(ethylene-co-propylene). When the types of materials of the first base film and the second base film fall within the above ranges, the dual-separator structure, that is, the first separator and the second separator, disposed in the secondary battery improves the high-temperature thermal abuse performance of the secondary battery and prolongs the cycle life of the secondary battery while contributing to a desirable energy density.

In an embodiment of this application, the glass transition temperature Tg₁ of the first base film is 80° C. to 100° C., and the glass transition temperature Tg₂ of the second base film is 25° C. to 50° C. For example, the glass transition temperature Tg₁ of the first base film may be 80° C., 82° C., 85° C., 88° C., 90° C., 92° C., 95° C., 98° C., 100° C., or a value falling within a range formed by any two thereof; and the glass transition temperature Tg₂ of the second base film may be 25° C., 27° C., 30° C., 32° C., 35° C., 37° C., 40° C., 42° C., 45° C., 48° C., 50° C., or a value falling within a range formed by any two thereof. When the glass transition temperature of the first base film and the glass transition temperature of the second base film fall within the above ranges, a dual-separator structure containing the polymeric microporous film and the nonwoven fabric film is disposed in the secondary battery, thereby improving the high-temperature thermal abuse performance of the secondary battery and prolonging the cycle life of the secondary battery while achieving a desirable energy density. The methods for regulating the glass transition temperature of the first base film and the glass transition temperature of the second base film are not particularly limited herein, as long as the objectives of this application can be achieved. For example, the glass transition temperature may be regulated by selecting different types of nonwoven fabric films and polymeric microporous films. In this application, understandably, the glass transition temperature of the nonwoven fabric film is the glass transition temperature Tg₁ of the first base film, and the glass transition temperature of the polymeric microporous film is the glass transition temperature Tg₂ of the second base film.

In an embodiment of this application, the first ceramic coating further includes a first ceramic coating binder, and the second ceramic coating further includes a second ceramic coating binder. The types of the first ceramic coating binder and the second ceramic coating binder are not particularly limited herein, as long as the objectives of this application can be achieved. For example, the first ceramic coating binder and the second ceramic coating binder each are at least one independently selected from styrene-butadiene rubber, polyvinyl alcohol, polyvinylidene fluoride, polyacrylic acid, polymethyl methacrylate, polybutyl acrylate, or polyacrylonitrile. The content of the first ceramic particles and the content of the first ceramic coating binder in the first ceramic coating, and the content of the second ceramic particles and the content of the second ceramic coating binder in the second ceramic coating, are not particularly limited herein, and may be selected by a person skilled in the art as actually required, as long as the objectives of this application can be achieved.

In an embodiment of this application, the first adhesive layer may include a first thickener, and the second adhesive layer may further include a second thickener. Applying the first thickener to the first adhesive layer and applying the second thickener to the second adhesive layer can increase the stability of the first adhesive layer slurry and the second adhesive layer slurry, and prevent the sedimentation of each constituent in the first adhesive layer slurry and the second adhesive layer slurry. The types of the first thickener and the second thickener are not particularly limited herein, as long as the objectives of this application can be achieved. For example, the first thickener and the second thickener each independently are at least one selected from hydroxyethyl cellulose, methyl hydroxyethyl cellulose, sodium carboxymethyl cellulose, polyacrylamide, or sodium alginate. The content of the first thickener in the first adhesive layer and the content of the second thickener in the second adhesive layer are not particularly limited herein, and may be selected by a person skilled in the art as actually required, as long as the objectives of this application can be achieved.

The method for preparing the first separator is not particularly limited herein, as long as the objectives of this application can be achieved. For example, the preparation method of the first separator includes, but is not limited to, the following steps: (1) mixing the first binder with the first thickener well to obtain a first adhesive layer slurry; (2) mixing first ceramic particles with a first ceramic coating binder well to obtain a first ceramic coating slurry; (3) applying the first ceramic coating slurry onto one surface of a first base film, oven-drying the slurry to form a first ceramic coating on one surface of the first base film, applying the first adhesive layer slurry onto a surface of the first ceramic coating on a side away from the first base film, oven-drying the slurry to obtain a first separator coated with the first ceramic coating and the first adhesive layer on one side; and (4) repeating the above steps on the other surface of the first base film to obtain a first separator. In an embodiment of this application, after step (3) above, the other surface of the first base film may be coated with only the first adhesive layer slurry, and then oven-dried to obtain a first separator.

The method for preparing the second separator is not particularly limited herein, as long as the objectives of this application can be achieved. For example, the preparation method of the second separator includes, but is not limited to, the following steps: (1) mixing a second binder with a second thickener well to obtain a second adhesive layer slurry; (2) mixing second ceramic particles with a second ceramic coating binder well to obtain a second ceramic coating slurry; (3) applying the second ceramic coating slurry onto one surface of a second base film, oven-drying the slurry to form a second ceramic coating on one surface of the second base film, applying the second adhesive layer slurry onto a surface of the second ceramic coating on a side away from the second base film, oven-drying the slurry to obtain a second separator coated with the second ceramic coating and the second adhesive layer on one side; and (4) repeating the above steps on the other surface of the second base film to obtain a second separator. In an embodiment of this application, after step (3) above, the other surface of the second base film may be coated with only the second adhesive layer slurry, and then oven-dried to obtain a second separator.

The negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector (such as a lithium-copper composite current collector, a carbon-copper composite current collector, a nickel-copper composite current collector, or a titanium-copper composite current collector), or the like. The first negative electrode material layer and the second negative electrode material layer of this application each independently contain a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ(0<x<2), Li—Sn alloy, Li—Sn—O alloy, Sn, SnO, SnO₂, spinel-structured lithium titanium oxide Li₄Ti₅O₁₂, Li—Al alloy, or metallic lithium. The thickness of the negative current collector is not particularly limited herein, as long as the objectives of this application can be achieved. For example, the thickness of the negative current collector is 4 μm to 15 μm. Optionally, the first negative electrode material layer and the second negative electrode material layer each may further include a conductive agent and a negative electrode binder. The types of the conductive agents in the first negative electrode material layer and the second negative electrode material layer are not particularly limited herein, as long as the objectives of this application can be achieved. For example, the conductive agent may include, but is not limited to, at least one of conductive carbon black (Super P), carbon nanotubes (CNTs), carbon fibers, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The types of the negative electrode binders in the first negative electrode material layer and the second negative electrode material layer are not particularly limited herein, as long as the objectives of this application can be achieved. For example, the negative electrode binder may include, but is not limited to, at least one of polyvinylidene fluoride, poly(vinylidene fluoride-co-hexafluoropropylene), polyamide, polyacrylonitrile, polyacrylate, polyacrylic acid, polyacrylic acid sodium salt, polyvinylpyrrolidone, polyvinyl ether, polymethyl methacrylate, polytetrafluoroethylene, or polyhexafluoropropylene. The mass ratio between the negative active material, conductive agent, and negative electrode binder in the first negative electrode material layer and the second negative electrode material layer is not particularly limited herein, as long as the objectives of this application can be achieved.

In this application, “positive electrode material layer located on at least one surface of the positive current collector” means that the positive electrode material layer may be disposed on one surface of the positive current collector or on both surfaces of the positive current collector along the thickness direction of the current collector. It is hereby noted that the “surface” here may be the entire region of the surface of the positive current collector, or a partial region of the surface of the positive current collector, without being particularly limited herein, as long as the objectives of the application can be achieved. The positive current collector is not particularly limited herein, as long as the objectives of this application can be achieved. For example, the positive current collector may include aluminum foil, aluminum alloy foil, a composite current collector (such as an aluminum carbon composite current collector), or the like. The positive electrode material layer of this application includes a positive active material. The type of the positive active material is not particularly limited herein, as long as the objectives of this application can be achieved. For example, the positive active material may include at least one of lithium nickel cobalt manganese oxide (NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metal element. For example, the non-metal element includes at least one of fluorine, phosphorus, boron, chlorine, silicon, or sulfur. The thickness of the positive current collector is not particularly limited herein, as long as the objectives of this application can be achieved. For example, the thickness of the positive current collector is 9 μm to 15 μm. In this application, the positive electrode material layer may further include a conductive agent and a positive electrode binder. The type of the conductive agent in the positive electrode material layer is not particularly limited herein, as long as the objectives of this application can be achieved. The conductive agent may be of the same type as the conductive agents in the first negative electrode material layer and the second negative electrode material layer. The type of the positive electrode binder in the positive electrode material layer is not particularly limited herein, as long as the objectives of this application can be achieved. The positive electrode binder may be of the same type as the negative electrode binders in the first negative electrode material layer and the second negative electrode material layer. The mass ratio between the positive active material, the conductive agent, and the positive electrode binder in the positive electrode material layer is not particularly limited herein, and may be selected by a person skilled in the art as actually required, as long as the objectives of this application can be achieved.

The secondary battery in this application includes an electrolyte solution. The electrolyte solution includes a lithium salt and a nonaqueous solvent. The lithium salt may include at least one of LiPF₆, LiNO₃, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato) borate (LiBOB), lithium bis(trifluoromethanesulfonyl)imide (LiTFSI), or lithium difluoroborate. The content of the lithium salt in the electrolyte solution is not particularly limited herein, as long as the objectives of this application can be achieved. The nonaqueous solvent is not particularly limited herein, as long as the objectives of this application can be achieved. For example, the nonaqueous solvent includes, but is not limited to, at least one of a carbonate ester compound, a carboxylate ester compound, an ether compound, or another organic solvent. The carbonate compound may include, but is not limited to, at least one of a chain carbonate compound, a cyclic carbonate compound, or a fluorocarbonate compound. The chain carbonate compound may include, but is not limited to, at least one of dimethyl carbonate, diethyl carbonate, dipropyl carbonate, methyl propyl carbonate, ethylene propyl carbonate, or ethyl methyl carbonate. The cyclic carbonate compound may include, but is not limited to, at least one of ethylene carbonate, propylene carbonate (PC), butylene carbonate, or vinyl ethylene carbonate. The fluorocarbonate compound may include, but is not limited to, at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvent may include, but is not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery of this application further includes a packaging bag. The packaging bag is configured to accommodate a positive electrode plate, a negative electrode plate, a separator, an electrolyte solution, and other components known in the art for use in a secondary battery. Such other components are not limited herein. The packaging bag is not particularly limited herein, and may be a packaging bag well-known in the art, as long as the objectives of this application can be achieved.

The secondary battery is not particularly limited in this application, and may be any device in which an electrochemical reaction occurs. In an embodiment of this application, the secondary battery may be, but is not limited to, a lithium-ion secondary battery (lithium-ion battery), a lithium polymer secondary battery, a lithium-ion polymer secondary battery, or the like.

The method for preparing the secondary battery is not particularly limited herein, and may be any preparation method well-known in the art, as long as the objectives of this application can be achieved. For example, the method for preparing the secondary battery includes, but is not limited to, the following steps: stacking the positive electrode plate, the first separator, the negative electrode plate, and the second separator in sequence, and performing operations such as winding and folding as required on the stacked structure to obtain a jelly-roll electrode assembly; putting the electrode assembly into a packaging bag, injecting an electrolyte solution into the packaging bag, and sealing the package bag to obtain a secondary battery.

A second aspect of this application provides an electronic device. The electronic device includes the secondary battery disclosed in any one of the preceding embodiments. The secondary battery of this application exhibits good high-temperature performance and achieves a relatively long cycle life in addition to a desirable energy density. Therefore, the electronic device of this application achieves a relatively long service life.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to embodiments and comparative embodiments. Various tests and evaluations are performed by the following methods.

### Test Methods and Devices

### Method for Sampling First Separators and Second Separators

Disassembling a lithium-ion battery in each embodiment and comparative embodiment to be tested, taking out a first separator and a second separator, and soaking the separators in dimethyl carbonate (DMC) for 20 minutes to remove residual electrolyte solution. Subsequently, drying the first separator and the second separator in an oven at 60° C. for 12 hours to obtain a first separator sample and a second separator sample. The first separator and the second separator are sampled by the above method in the following tests to determine the average particle diameters of the first ceramic particles and the second ceramic particles, determine the average pore diameters of the first base film and the second base film, determine the thicknesses of the first ceramic coating, the second ceramic coating, the first base film, and the second base film, and determine the glass transition temperatures of the first base film and the second base film.

### Determining the Average Particle Diameters of the First Ceramic Particles and the Second Ceramic Particles

Sectioning the first separator or the second separator along a thickness direction of the separator by argon ion polishing to obtain a cross-section of the separator. Observing the cross-section of the first separator or the second separator by using a scanning electron microscope (SEM). Measuring the equivalent diameter of 10 first ceramic particles and the equivalent diameter of 10 second ceramic particles separately (that is, for a particle with an irregular cross-section, the equivalent diameter is the diameter of a circle of the same area as the particle). Averaging out the measured values to obtain an average particle diameter of the first ceramic particles or the average particle diameter of the second ceramic particles.

### Determining the Average Pore Diameters of the First Base Film and the Second Base Film

Placing the obtained first separator sample and second separator sample into a container, adding an appropriate amount of N-methylpyrrolidone (NMP), and putting the container into an ultrasonic instrument with a heating function for ultrasonication. Setting the temperature to 45° C., and keeping the ultrasonication for 3 hours. Taking out the container when the first separator and the second separator become completely transparent, so as to obtain a first base film sample and a second base film sample. Fixing the sample with 5% osmic acid, and then dehydrating the sample stepwise with ethanol in an extractor, and then embedding and curing the sample with epoxy resin. Finally, cutting the sample into thin slices by using an ultrathin slicer. Subsequently, observing and measuring sample with a scanning electron microscope SEM.

### Determining the Thicknesses of the First Ceramic Coating, the Second Ceramic Coating, the First Base Film, and the Second Base Film

Performing argon ion beam cross-section polishing on the first separator to obtain a cross-section of the first separator, and observing the morphology of the cross-section of the first separator along the thickness direction by using a field emission scanning electron microscope (XL-30, from Philips), and capturing a scanning electron microscope image. Measuring the thickness H₁ of the first ceramic coating and the thickness h₁ of the first base film by using the scanning electron microscope.

Performing argon ion beam cross-section polishing on the second separator to obtain a cross-section of the second separator, and observing the morphology of the cross-section of the second separator along the thickness direction by using a field emission scanning electron microscope (XL-30, from Philips), and capturing a scanning electron microscope image. Measuring the thickness H₂ of the second ceramic coating and the thickness h₂ of the second base film by using the scanning electron microscope.

### Determining the Glass Transition Temperatures of the First Base Film and the Second Base Film

Placing the obtained first separator sample and second separator sample into a container, adding an appropriate amount of N-methylpyrrolidone (NMP), and putting the container into an ultrasonic instrument with a heating function for ultrasonication. Setting the temperature to 45° C., and keeping the ultrasonication for 3 hours. Taking out the container when the first separator and the second separator become completely transparent, so as to obtain a first base film sample and a second base film sample.

Testing the glass transition temperature of a nonwoven fabric film (the first base film sample) and a polymeric microporous film (the second base film sample) by using a differential scanning calorimeter (DSC). Die-cutting the first base film sample and the second base film sample by using a die, so as to prepare specimen (a person skilled in the art may select the die of a typical size and shape in the art based on factors such as the dimensions and shape of the specimen and the requirements of the test instrument). Hermetically packaging the prepared specimen in a ziplock bag to avoid contamination. During the test, taking out the specimen and placing the specimen into a crucible. Putting the crucible into a furnace. Increasing the temperature from −100° C. to 800° C. at a heating rate of 5° C./min. Controlling the temperature change by using a program. Determining the relationship between a power difference (a difference in power between the specimen and a reference, that is, heat flow rate) and the measured temperature of the specimen during change of the temperature, so as to obtain the melting point, crystallinity, crystallization temperature, and other information of the specimen. Obtaining, through a DSC curve, the glass transition temperature of the specimen, that is, the glass transition temperature Tg₁ of the nonwoven fabric film and the glass transition temperature Tg₂ of the polymeric microporous film.

### Determining the Adhesion of the Separator to the Electrode Plate

Measuring dry-pressing adhesion between the separator and the electrode plate with reference to a 180° peeling test standard. Disassembling the lithium-ion batteries in the tested embodiment and comparative embodiment, and taking out the positive electrode plate, the negative electrode plate, the first separator, and the second separator.

Soaking the to-be-tested electrode plate and separator in dimethyl carbonate for 20 minutes to remove the electrolyte solution, and then laminating the separator sample and the electrode plate sample, and hot-pressing the laminated plates by using a hot press at 85° C. under a pressure of 1 MPa for 85 seconds. Cutting the laminated sample into 15 mm×54.2 mm strips to obtain test strips for testing the adhesion of the separator sample to the electrode plate sample. Sticking a 15 mm×55 mm double-sided tape (Nitto No. 5000NS) to a steel sheet, and then sticking the test strip onto the double-sided tape, with the test side facing down. Connecting a 15 mm×70 mm paper strip to one end of the test strip by using double-sided tape, and pushing a small stick of a 2 kg weight by hand to roll on the test strip 8 times to obtain a specimen. Measuring the adhesion by using a tensile tester. Fixing the specimen onto a specimen bench, folding the paper strip upward by 180°, and fixing the paper strip with a jig. Subsequently, using a tensile tester to pull the paper strip at a speed of 50 mm/min until the separator sample on the surface of the double-sided tape is detached from the electrode plate sample. Recording the test data. Calculating the adhesion F (N/m) between the separator sample and the electrode plate sample based on the tensile force applied and the tensile displacement caused when the separator sample is detached from the electrode plate. The adhesion of the first separator to the negative electrode plate is F₁ in N/m; the adhesion of the second separator to the positive electrode plate is F₂ in N/m; and the adhesion of the second separator to the negative electrode plate is F₃ in N/m.

### Determining the Thickness of the Lithium-Ion Battery

Adjusting, by adding or removing a weight, the test pressure to a 600 g pressure required by the voltage, placing a 3 mm gauge block onto a loading platform, pressing the white buttons on both sides of the instrument so that the parallel plate gauge (PPG battery thickness gauge) automatically feeds the gauge block into the instrument and tests the thickness. Measuring any 9 points in sequence, with a calibration tolerance of ±0.02 mm. Using only the item that falls within the specification range. Holding the lithium-ion battery with one hand, placing the battery on the loading platform with the barcode facing up. Scanning the barcode first, and then pressing the white buttons on both sides so that the instrument automatically feeds the lithium-ion battery for testing. Recording the test result, that is, the thickness of the lithium-ion battery.

### High-Temperature Hot-Oven Test

Charging a lithium-ion battery at 25° C. at a constant current of 2 C until the voltage reaches 4.5 V, and then charging the battery at a constant voltage of 4.5 V until the current tapers off to 0.02 C. Subsequently, leaving the lithium-ion battery to stand for 5 minutes in a test chamber ventilated with air at a temperature of 25° C. and a humidity of 80%, and then heating the test chamber to 130° C. at a rate of 5° C./min. Keeping the temperature constant at 130° C. for 10 minutes, and then checking whether the lithium-ion battery catches fire or explodes. Calculating the 130° C. hot-oven test pass rate as: hot-oven test pass rate=number of batteries passing the 130° C. hot-oven test/10 (total number of batteries tested in 130° C. hot oven).

Charging a lithium-ion battery at 25° C. at a constant current of 2 C until the voltage reaches 4.5 V, and then charging the battery at a constant voltage of 4.5 V until the current tapers off to 0.02 C. Subsequently, leaving the lithium-ion battery to stand for 5 minutes in a test chamber ventilated with air at a temperature of 25° C. and a humidity of 80%, and then heating the test chamber to 135° C. at a rate of 5° C./min. Keeping the temperature constant at 135° C. for 10 minutes, and then checking whether the lithium-ion battery catches fire or explodes. Calculating the 135° C. hot-oven test pass rate as: hot-oven test pass rate=number of batteries passing the 135° C. hot-oven test/10 (total number of batteries tested in 135° C. hot oven).

### Testing the Cycle Performance

Charging a lithium-ion battery at a constant current of 2 C at 25° C. until the voltage reaches 4.5 V, and then charging the battery at a constant voltage of 4.5 V until the current tapers off to 0.02 C. Leaving the battery to stand for 5 minutes, and then discharging the battery at a constant current of 0.7 C until the voltage drops to 3.0 V, thereby completing a first cycle. Recording the discharge capacity at this time. Charging and discharging the lithium-ion battery according to the above process until completion of 1000 cycles (cls). Calculating the capacity retention rate as a metric of the cycle performance of the lithium-ion battery.

Capacity retention rate (%)=(1000^{th}-cycle discharge capacity/first-cycle discharge capacity)×100%.

### Embodiment 1-1

### <Preparing a First Separator>

Using a nonwoven fabric film as a first base film, where the thickness h₁ of the nonwoven fabric film is 12 μm, the glass transition temperature Tg₁ of the nonwoven fabric film is 90° C., the material of the nonwoven fabric film is polyethylene terephthalate, and the average pore diameter d₁ of the first base film is 500 nm (manufacturer: TPSHB, designation: 00TH-15S).

Mixing polyvinylidene fluoride (PVDF, with weight-average molecular weight Mw=8.5×10⁶) as a first binder and sodium carboxymethyl cellulose (Mw=8×10⁵) as a thickener at a mass ratio of 98.5:1.5, adding deionized water as a solvent, and stirring well to form a first adhesive layer slurry in which the solid content is 75 wt %.

Mixing aluminum oxide (Al₂O₃) as first ceramic particles, styrene-butadiene rubber (Mw=7×10⁶) as a first ceramic coating binder, and a deionized water solvent at a mass ratio of 35:10:55 to obtain a first ceramic coating slurry.

Applying the first ceramic coating slurry onto one surface of a first base film, oven-drying the slurry at 60° C. to form a first ceramic coating on one surface of the first base film, applying the first adhesive layer slurry onto a surface of the first ceramic coating on a side away from the first base film, oven-drying the slurry at 60° C. to obtain a first separator coated with the first ceramic coating and the first adhesive layer on one side. Subsequently, repeating the above steps on the other surface of the first base film to obtain a first separator. The thickness H₁ of the first ceramic coating is 1.2 μm, and the average particle diameter D₁ of the first ceramic particles is 1 μm.

### <Preparing a Second Separator>

Using a polymeric microporous film as a second base film, where the thickness h₂ of the film is 7 μm, the glass transition temperature Tg₂ of the film is 40° C., the material of the polymeric microporous film is polypropylene and polyethylene mixed at a mass ratio of 1:1, and the average pore diameter d₂ of the second base film is 100 nm (manufacturer: i-Quip, designation: P492780).

Mixing polyimide (PI, with weight-average molecular weight Mw=6×10⁵) as a second binder and sodium carboxymethyl cellulose (Mw=8×10⁵) as a second thickener at a mass ratio of 98.5:1.5, adding deionized water as a solvent, and stirring well to form a second bonding layer slurry in which the solid content is 75 wt %.

Mixing boehmite (γ-AlOOH) as second ceramic particles, styrene-butadiene rubber (Mw=7×10⁶) as a second ceramic coating binder, and a deionized water solvent at a mass ratio of 35:10:55 to obtain a second ceramic coating slurry.

Applying the second ceramic coating slurry onto one surface of a second base film, oven-drying the slurry at 60° C. to form a second ceramic coating on one surface of the second base film, applying the second adhesive layer slurry onto a surface of the first ceramic coating on a side away from the first base film, oven-drying the slurry at 60° C. to obtain a second separator coated with the second ceramic coating and the second adhesive layer on one side. Subsequently, applying the second adhesive layer slurry onto the other surface of the second base film, and oven-drying the slurry at 60° C. to obtain a second separator. The thickness H₂ of the second ceramic coating is 0.7 μm, and the average particle diameter D₂ of the second ceramic particles is 0.5 μm.

### <Preparing a Negative Electrode Plate>

Mixing artificial graphite as a negative active material, styrene-butadiene rubber, and sodium carboxymethyl cellulose at a mass ratio of 97.0:1.5:1.5, adding deionized water as a solvent, and stirring well to obtain a first negative electrode slurry in which the solid content is 70 wt %. At the same time, the first negative electrode slurry also serves as a second negative electrode slurry. Applying the first negative electrode slurry onto one surface of a 6 μm-thick negative current collector copper foil, and oven-drying the slurry at 90° C. to obtain a negative electrode plate coated with a 50 μm-thick first negative electrode material layer. Applying the second negative electrode slurry onto the other surface of the negative current collector copper foil, and oven-drying the slurry to obtain a 106 μm-thick negative electrode plate coated with a 50 μm-thick second negative electrode material layer. Cold-pressing and then cutting the coated negative electrode plate into sheets of 74 mm×824 mm in size for future use. The compaction density of the first negative electrode material layer is 1.735 g/cm³, and the length of the first negative electrode material layer is 720 mm. The compaction density of the second negative electrode material layer is 1.735 g/cm³, and the length of the second negative electrode material layer is 680 mm.

### <Preparing a Positive Electrode Plate>

Mixing lithium cobalt oxide as a positive active material, conductive carbon black as a conductive agent, and polyvinylidene fluoride (PVDF) as a positive electrode binder at a mass ratio of 96:2:2, and then adding N-methyl pyrrolidone (NMP) as a solvent, stirring well to obtain a positive electrode slurry in which the solid content is 75 wt %. Applying the positive electrode slurry evenly onto one surface of a 10 μm-thick positive current collector aluminum foil, and oven-drying the slurry at 90° C. to obtain a positive electrode plate coated with a 55 μm-thick positive electrode material layer on a single side. Applying the positive electrode slurry onto the other surface of the positive current collector aluminum foil, and oven-drying the slurry to obtain a 120 μm-thick positive electrode plate coated with a 55 μm-thick positive electrode material layer on both sides. Cold-pressing and then cutting the coated positive electrode plate into sheets of 70 mm×800 mm in size for future use. The compaction density of the positive electrode material layer is 4.23 g/cm³.

### <Preparing an Electrolyte Solution>

Mixing propylene carbonate (PC), diethyl carbonate (DEC), and ethylene carbonate (EC) at a mass ratio of 1:1:1 in a dry argon atmosphere glovebox to form a base solvent, and then adding hexafluorophosphate (LiPF₆) as a lithium salt into the base solvent to dissolve, and stirring well to obtain an electrolyte solution. Based on the mass of the electrolyte solution, the mass percent of LiPF₆ is 4.5%, and the remainder is the base solvent.

### <Preparing a Lithium-Ion Battery>

Stacking the above-prepared positive electrode plate, second separator, negative electrode plate, and first separator in sequence, and then winding the stacked structure to obtain an electrode assembly. Leading out a positive tab by spot-welding the aluminum foil, and leading out a negative tab by spot-welding the nickel foil. The second ceramic coating in the second separator faces away from the negative electrode plate. The first negative electrode material layer is close to the first separator, and the second negative electrode material layer is close to the second separator. Putting the electrode assembly into an aluminum laminated film, leaving the electrode assembly in an 80° C. vacuum oven for 12 hours to dehydrate, and then injecting the above-prepared electrolyte solution to form a cell. Performing vacuum sealing, standing, chemical formation (charging the cell at a constant current of 0.02 C until the voltage reaches 3.5 V, and then charging the cell at a constant current of 0.1 C until the voltage reaches 3.9 V), capacity grading, and shaping to obtain a lithium-ion battery.

### Embodiments 1-2 to 1-9

Identical to Embodiment 1-1 except that the relevant preparation parameters are adjusted according to Table 1.

### Embodiment 1-10

Identical to Embodiment 1-1 except that the lithium-ion battery is prepared by the following steps:

### <Preparing a Lithium-Ion Battery>

Stacking the prepared positive electrode plate, first separator, negative electrode plate, and second separator in sequence, and then winding the stacked structure to obtain an electrode assembly. Leading out a positive tab by spot-welding the aluminum foil, and leading out a negative tab by spot-welding the nickel foil. The second ceramic coating in the second separator faces away from the negative electrode plate. The first negative electrode material layer is close to the second separator, and the second negative electrode material layer is close to the first separator. Putting the electrode assembly into an aluminum laminated film, leaving the electrode assembly in an 80° C. vacuum oven for 12 hours to dehydrate, and then injecting the above-prepared electrolyte solution to form a cell. Performing vacuum sealing, standing, chemical formation (charging the cell at a constant current of 0.02 C until the voltage reaches 3.5 V, and then charging the cell at a constant current of 0.1 C until the voltage reaches 3.9 V), capacity grading, and shaping to obtain a lithium-ion battery.

### Embodiment 1-11

Identical to Embodiment 1-1 except that the second separator is prepared by the following steps:

### <Preparing a Second Separator>

Using a polymeric microporous film as a second base film, where the thickness h₂ of the film is 7 μm, the glass transition temperature Tg₂ of the film is 40° C., the material of the polymeric microporous film is polypropylene and polyethylene mixed at a mass ratio of 1:1, and the average pore diameter d₂ of the second base film is 100 nm (manufacturer: i-Quip, designation: P492780).

Mixing polyimide (PI, with weight-average molecular weight Mw=6×10⁵) as a second binder and sodium carboxymethyl cellulose (Mw=8×10⁵) as a second thickener at a mass ratio of 98.5:1.5, adding deionized water as a solvent, and stirring well to form a second bonding layer slurry in which the solid content is 75 wt %.

Mixing boehmite (γ-AlOOH) as second ceramic particles, styrene-butadiene rubber (Mw=7×10⁶) as a second ceramic coating binder, and a deionized water solvent at a mass ratio of 35:10:55 to obtain a second ceramic coating slurry.

Applying the second ceramic coating slurry onto one surface of a second base film, oven-drying the slurry at 60° C. to form a second ceramic coating on one surface of the second base film, applying the second bonding layer slurry onto a surface of the first ceramic coating on a side away from the first base film, oven-drying the slurry at 60° C. to obtain a second separator coated with the second ceramic coating and the second bonding layer on one side. Subsequently, repeating the above steps on the other surface of the second base film to obtain a second separator. The thickness H₂ of the second ceramic coating is 0.7 μm, and the average particle diameter D₂ of the second ceramic particles is 0.5 μm.

### Embodiments 2-1 to 2-14

Identical to Embodiment 1-1 except that the relevant preparation parameters are adjusted according to Table 2.

### Comparative Embodiments 1 to 4

Identical to Embodiment 1-1 except that the relevant preparation parameters are adjusted according to Table 1.

Table 1 to Table 2 show the preparation parameters and performance parameters of each embodiment and each comparative embodiment.

TABLE 1

| | | Material | | Material of | | | First | Second |
|---|---|---|---|---|---|---|---|---|
| | First base | of first | | second base | First | Second | ceramic | ceramic |
| | film | base film | Second base film | film | binder | binder | particles | particles |
| Embodiment | Nonwoven | PET | Polymeric | PP + PE (mass | PVDF | PI | Al₂O₃ | γ-AlOOH |
| 1-1 | fabric film | | microporous film | ratio 1:1) | | | | |
| Embodiment | Nonwoven | PET | Polymeric | PP + PE (mass | PVDF | PVA | ZrO₂ | γ-AlOOH |
| 1-2 | fabric film | | microporous film | ratio 1:1) | | | | |
| Embodiment | Nonwoven | PET | Polymeric | PP + PE (mass | PVDF- | PI | Al₂O₃ | γ-AlOOH |
| 1-3 | fabric film | | microporous film | ratio 1:1) | HFP | | | |
| Embodiment | Nonwoven | PET | Polymeric | PP + PE (mass | PVDF- | PI | TiO₂ | γ-AlOOH |
| 1-4 | fabric film | | microporous film | ratio 1:1) | HFP | | | |
| Embodiment | Nonwoven | PET | Polymeric | PP + PE (mass | PVDF- | CMC-Na | SiO₂ | γ-AlOOH |
| 1-5 | fabric film | | microporous film | ratio 1:1) | HFP | | | |
| Embodiment | Nonwoven | PET | Polymeric | PP | PVDF | PI | Al₂O₃ | γ-AlOOH |
| 1-6 | fabric film | | microporous film | | | | | |
| Embodiment | Nonwoven | PET | Polymeric | PE | PVDF | PI | Al₂O₃ | γ-AlOOH |
| 1-7 | fabric film | | microporous film | | | | | |
| Embodiment | Nonwoven | Polyacrylonitrile | Polymeric | PP + PE (mass | PVDF | PI | Al₂O₃ | γ-AlOOH |
| 1-8 | fabric film | | microporous film | ratio 1:1) | | | | |
| Embodiment | Nonwoven | Polyphenylene | Polymeric | PP + PE (mass | PVDF | PI | Al₂O₃ | γ-AlOOH |
| 1-9 | fabric film | sulfide | microporous film | ratio 1:1) | | | | |
| Embodiment | Nonwoven | PET | Polymeric | PP + PE (mass | PVDF | PI | Al₂O₃ | γ-AlOOH |
| 1-10 | fabric film | | microporous film | ratio 1:1) | | | | |
| Embodiment | Nonwoven | PET | Polymeric | PP + PE (mass | PVDF | PI | Al₂O₃ | γ-AlOOH |
| 1-11 | fabric film | | microporous film | ratio 1:1) | | | | |
| Comparative | Polymeric | PP + PE | Polymeric | PP + PE (mass | PVDF | PVDF | Al₂O₃ | Al₂O₃ |
| Embodiment | microporous | (mass | microporous film | ratio 1:1) | | | | |
| 1 | film | ratio 1:1) | | | | | | |
| Comparative | Polymeric | PP + PE | Polymeric | PP + PE (mass | PI | PI | γ-AlOOH | γ-AlOOH |
| Embodiment | microporous | (mass | microporous film | ratio 1:1) | | | | |
| 2 | film | ratio 1:1) | | | | | | |
| Comparative | Nonwoven | PET | Nonwoven fabric | PET | PVDF | PVDF | Al₂O₃ | Al₂O₃ |
| Embodiment | fabric film | | film | | | | | |
| 3 | | | | | | | | |
| Comparative | Nonwoven | PET | Nonwoven fabric | PET | PVA | PVA | γ-AlOOH | γ-AlOOH |
| Embodiment | fabric film | | film | | | | | |
| 4 | | | | | | | | |

| | | | | | | Capacity | Thickness of | 130° C. hot- | 135° C. hot- |
|---|---|---|---|---|---|---|---|---|---|
| | Tg₁ | Tg₂ | F₁ | F₂ | F₃ | retention rate | lithium-ion | oven test pass | oven test pass |
| | (° C.) | (° C.) | (N/m) | (N/m) | (N/m) | (%) | battery (mm) | rate | rate |
| Embodiment | 90 | 40 | 9.1 | 8.2 | 17.2 | 90 | 5.30 | 10/10 | 9/10 |
| 1-1 | | | | | | | | | |
| Embodiment | 90 | 40 | 9.3 | 7.6 | 16.2 | 85 | 5.30 | 10/10 | 7/10 |
| 1-2 | | | | | | | | | |
| Embodiment | 90 | 40 | 10.2 | 8.2 | 17.1 | 91 | 5.30 | 10/10 | 10/10 |
| 1-3 | | | | | | | | | |
| Embodiment | 90 | 40 | 10.3 | 8.3 | 17.2 | 87 | 5.30 | 9/10 | 7/10 |
| 1-4 | | | | | | | | | |
| Embodiment | 90 | 40 | 10.3 | 7.7 | 16.4 | 86 | 5.30 | 8/10 | 5/10 |
| 1-5 | | | | | | | | | |
| Embodiment | 90 | 50 | 9.2 | 8.5 | 17.2 | 87 | 5.30 | 10/10 | 8/10 |
| 1-6 | | | | | | | | | |
| Embodiment | 90 | 25 | 9.3 | 8.3 | 17.3 | 87 | 5.30 | 10/10 | 7/10 |
| 1-7 | | | | | | | | | |
| Embodiment | 100 | 40 | 9.2 | 8.1 | 17.2 | 89 | 5.30 | 10/10 | 10/10 |
| 1-8 | | | | | | | | | |
| Embodiment | 80 | 40 | 9.1 | 8.2 | 17.5 | 88 | 5.30 | 10/10 | 8/10 |
| 1-9 | | | | | | | | | |
| Embodiment | 90 | 40 | 9.5 | 8.4 | 17.1 | 83 | 5.30 | 10/10 | 10/10 |
| 1-10 | | | | | | | | | |
| Embodiment | 90 | 40 | 9.2 | 8.2 | 17.1 | 91 | 5.35 | 10/10 | 5/10 |
| 1-11 | | | | | | | | | |
| Comparative Embodiment | 40 | 40 | 9.3 | 6.7 | 9.4 | 89 | 5.28 | 4/10 | 0/10 |
| 1 | | | | | | | | | |
| Comparative Embodiment | 40 | 40 | 17.3 | 9.5 | 17.2 | 86 | 5.28 | 7/10 | 0/10 |
| 2 | | | | | | | | | |
| Comparative Embodiment | 90 | 90 | 9.4 | 6.3 | 9.41 | 92 | 5.32 | 6/10 | 2/10 |
| 3 | | | | | | | | | |
| Comparative Embodiment | 90 | 90 | 16.4 | 7.8 | 16.3 | 78 | 5.32 | 10/10 | 10/10 |
| 4 | | | | | | | | | |

As can be seen from Embodiments 1-1 to 1-11 and Comparative Embodiments 1 to 4, the secondary battery contains a dual-separator structure. The types of materials in different layers of the first separator and the types of materials in different layers of the second separator are controlled within the range specified herein. The values of F₁, F₂, and F₃ are relatively large. In other words, the adhesion of the first separator to the negative electrode plate, and the adhesion of the second separator to the positive electrode plate, and the adhesion of the second separator to the negative electrode plate are relatively large. The thickness of the lithium-ion battery is relatively small, indicating that the energy density of the lithium-ion battery with the same volume is relatively high. The capacity retention rate and the hot-oven test pass rate at 130° C. and 135° C. are relatively high, indicating that the lithium-ion battery of this application exhibits a relatively long cycle life and superior high-temperature thermal abuse performance while achieving a relatively high energy density. In Comparative Embodiment 1, both the first base film and the second base film are polymeric microporous film, both the first binder and the second binder are polyvinylidene fluoride, and both the first ceramic particles and the second ceramic particles are aluminum oxide. In Comparative Embodiment 1, the adhesion of the second separator to the positive electrode plate and the adhesion of the second separator to the negative electrode plate are relatively small, and the hot-oven test pass rate of the lithium ion battery at 130° C. and 135° C. is lower, thereby failing to achieve superior high-temperature thermal abuse performance. In Comparative Embodiment 2, both the first base film and the second base film are a polymeric microporous film, both the first binder and the second binder are polyimide, and both the first ceramic particles and the second ceramic particles are boehmite. In Comparative Embodiment 2, the hot-oven test pass rate of the lithium ion battery at 130° C. and 135° C. is relatively low, especially the hot-oven test pass rate at 135° C. is even lower, thereby failing to achieve superior high-temperature thermal abuse performance. In Comparative Embodiment 3, both the first base film and the second base film are a nonwoven fabric film, both the first binder and the second binder are polyvinylidene fluoride, and both the first ceramic particles and the second ceramic particles are aluminum oxide. In Comparative Embodiment 3, the adhesion of the second separator to the positive electrode plate and the adhesion of the second separator to the negative electrode plate are relatively small, the thickness of the lithium ion battery is relatively large, and the hot-oven test pass rates at 130° C. and 135° C. are relatively low, thereby failing to achieve superior high-temperature thermal abuse performance. In Comparative Embodiment 4, both the first base film and the second base film are a nonwoven fabric film, both the first binder and the second binder are polyvinyl alcohol, and both the first ceramic particles and the second ceramic particles are bochmite. In Comparative Embodiment 4, the capacity retention rate of the lithium-ion battery is even lower, thereby failing to achieve a long cycle life. As can be seen from Embodiments 1-1 to 1-11, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high, indicating that the lithium-ion battery of this application exhibits a relatively long cycle life and good high-temperature thermal abuse performance while achieving a desirable energy density.

The material of the first base film and the material of the second base film typically affect the energy density, cycle life, and safety performance of the lithium-ion battery. As can be seen from Embodiment 1-1 and Embodiments 1-6 to 1-9, when the material of the first base film and the material of the second base film fall within the ranges specified herein, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high. The lithium-ion battery of this application exhibits a relatively long cycle life and superior high-temperature thermal abuse performance while achieving a desirable energy density.

The glass transition temperature Tg₁ of the first base film and the glass transition temperature Tg₂ of the second base film typically affect the energy density, cycle life, and safety performance of the lithium-ion battery. As can be seen from Embodiments 1-1 and Embodiments 1-6 to 1-9, when the glass transition temperature Tg₁ of the first base film and the glass transition temperature Tg₂ of the second base film fall within the range specified herein, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high. The lithium-ion battery of this application exhibits a relatively long cycle life and superior high-temperature thermal abuse performance while achieving a desirable energy density.

The structure of the electrode assembly typically affects the energy density, cycle life, and high-temperature thermal abuse performance of the lithium-ion battery. As can be seen from Embodiment 1-1 and Embodiments 1-10 to 1-11, when the structure of the electrode assembly falls within the range specified herein, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high. The lithium-ion battery of this application exhibits a relatively long cycle life and superior high-temperature thermal abuse performance while achieving a desirable energy density.

TABLE 2

| | D₁ | D₂ | H₁ | H₂ | | | | | | | |
|---|---|---|---|---|---|---|---|---|---|---|---|
| | (μm) | (μm) | (μm) | (μm) | d₁ (nm) | d₂ (μm) | h₁ (μm) | h₂ (μm) | F₁ (N/m) | F₂ (N/m) | F₃ (N/m) |
| Embodiment 1-1 | 1 | 0.5 | 1.2 | 0.7 | 500 | 100 | 12 | 7 | 9.1 | 8.2 | 17.2 |
| Embodiment 2-1 | 0.2 | 0.1 | 1.2 | 0.7 | 500 | 100 | 12 | 7 | 9.2 | 8.5 | 17.8 |
| Embodiment 2-2 | 1.2 | 1 | 1.2 | 0.7 | 500 | 100 | 12 | 7 | 9.1 | 8.1 | 16.9 |
| Embodiment 2-3 | 2.2 | 1.2 | 1.2 | 0.7 | 500 | 100 | 12 | 7 | 9.3 | 7.8 | 16.6 |
| Embodiment 2-4 | 0.2 | 0.1 | 0.5 | 0.3 | 500 | 100 | 12 | 7 | 9.3 | 8.5 | 17.9 |
| Embodiment 2-5 | 0.2 | 0.1 | 1.5 | 1.5 | 500 | 100 | 12 | 7 | 9.4 | 8.4 | 17.8 |
| Embodiment 2-6 | 0.2 | 0.1 | 0.3 | 0.2 | 500 | 100 | 12 | 7 | 9.3 | 8.3 | 17.6 |
| Embodiment 2-7 | 0.2 | 0.1 | 2.2 | 2.2 | 500 | 100 | 12 | 7 | 9.2 | 8.4 | 17.7 |
| Embodiment 2-8 | 1 | 0.5 | 1.2 | 0.7 | 80 | 50 | 12 | 7 | 9.1 | 8.3 | 17.3 |
| Embodiment 2-9 | 1 | 0.5 | 1.2 | 0.7 | 700 | 200 | 12 | 7 | 9.3 | 8.2 | 17.2 |
| Embodiment 2-10 | 1 | 0.5 | 1.2 | 0.7 | 1000 | 400 | 12 | 7 | 9.2 | 8.1 | 17.1 |
| Embodiment 2-11 | 1 | 0.5 | 1.2 | 0.7 | 500 | 100 | 10 | 3 | 9.1 | 8.2 | 17.2 |
| Embodiment 2-12 | 1 | 0.5 | 1.2 | 0.7 | 500 | 100 | 15 | 9 | 9.4 | 8.4 | 17.4 |
| Embodiment 2-13 | 1 | 0.5 | 1.2 | 0.7 | 500 | 100 | 8 | 2 | 9.3 | 8.3 | 17.5 |
| Embodiment 2-14 | 1 | 0.5 | 1.2 | 0.7 | 500 | 100 | 20 | 12 | 9.2 | 8.4 | 17.3 |

| | Capacity retention | Thickness of lithium-ion | 130° C. hot-oven test | 135° C. hot-oven test |
|---|---|---|---|---|
| | rate (%) | battery (mm) | pass rate | pass rate |
| Embodiment 1-1 | 90 | 5.30 | 10/10 | 9/10 |
| Embodiment 2-1 | 87 | 5.30 | 10/10 | 9/10 |
| Embodiment 2-2 | 91 | 5.30 | 10/10 | 7/10 |
| Embodiment 2-3 | 91 | 5.30 | 9/10 | 4/10 |
| Embodiment 2-4 | 86 | 5.29 | 10/10 | 8/10 |
| Embodiment 2-5 | 89 | 5.31 | 10/10 | 10/10 |
| Embodiment 2-6 | 85 | 5.28 | 9/10 | 6/10 |
| Embodiment 2-7 | 89 | 5.32 | 10/10 | 7/10 |
| Embodiment 2-8 | 88 | 5.30 | 10/10 | 9/10 |
| Embodiment 2-9 | 90 | 5.30 | 10/10 | 8/10 |
| Embodiment 2-10 | 90 | 5.30 | 9/10 | 7/10 |
| Embodiment 2-11 | 90 | 5.17 | 9/10 | 8/10 |
| Embodiment 2-12 | 90 | 5.41 | 10/10 | 9/10 |
| Embodiment 2-13 | 90 | 5.11 | 9/10 | 6/10 |
| Embodiment 2-14 | 90 | 5.58 | 10/10 | 9/10 |

The average particle diameter D₁ of the first ceramic particles and the average particle diameter D₂ of the second ceramic particles typically affect the energy density, cycle life, and high-temperature thermal abuse performance of the lithium-ion battery. As can be seen from Embodiment 1-1 and Embodiments 2-1 to 2-3, when the average particle diameter D₁ of the first ceramic particles and the average particle diameter D₂ of the second ceramic particles fall within the range specified herein, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high. The lithium-ion battery of this application exhibits a relatively long cycle life and superior high-temperature thermal abuse performance while achieving a desirable energy density. In Embodiment 2-3, the average particle diameter D₁ of the first ceramic particles and the average particle diameter D₂ of the second ceramic particles are relatively large. Therefore, the particles are more prone to pierce the separator and cause a short circuit in the hot-oven test, so that the high-temperature thermal abuse safety performance of the lithium-ion battery is slightly lower.

The thickness H₁ of the first ceramic coating and the thickness H₂ of the second ceramic coating typically affect the energy density, cycle life, and high-temperature thermal abuse performance of the lithium-ion battery. As can be seen from Embodiment 1-1 and Embodiments 2-4 to 2-7, when the thickness H₁ of the first ceramic coating and the thickness H₂ of the second ceramic coating fall within the range specified herein, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high. The lithium-ion battery of this application exhibits a relatively long cycle life and superior high-temperature thermal abuse performance while achieving a desirable energy density. In Embodiment 2-6, the thicknesses of the first ceramic coating and the second ceramic coating are relatively small, and therefore, the first ceramic coating is less capable of retaining the electrolyte solution and binding the first base film at high temperature, and the second ceramic coating is less capable of retaining the electrolyte solution and binding the second base film at high temperature, thereby improving the cycle performance and thermal abuse performance of the secondary battery to a lesser extent. In Embodiment 2-7, the thicknesses of the first ceramic coating and the second ceramic coating are relatively large, and therefore, causes a slight loss to the energy density. In addition, in the hot-oven test, the first ceramic particles and/or the second ceramic particles are more prone to pierce the separator and cause a short circuit, thereby exhibiting lower high-temperature thermal abuse performance.

The average pore diameter d₁ of the first base film and the average pore diameter d₂ of the second base film typically affect the energy density, cycle life, and high-temperature thermal abuse performance of the lithium-ion battery. As can be seen from Embodiment 1-1 and Embodiments 2-8 to 2-10, when the average pore diameter d₁ of the first base film and the average pore diameter d₂ of the second base film fall within the range specified herein, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high. The lithium-ion battery of this application exhibits a relatively long cycle life and superior high-temperature thermal abuse performance while achieving a desirable energy density. In Embodiment 2-10, the average pore diameter of the first base film and the average pore diameter of the second base film are relatively large. Therefore, the first ceramic particles and/or the second ceramic particles are more prone to pierce the separator and cause a short circuit in the hot-oven test, so that the high-temperature thermal abuse performance is slightly lower.

The thickness h₁ of the first base film and the thickness h₂ of the second base film typically affect the energy density, cycle life, and high-temperature thermal abuse performance of the lithium-ion battery. As can be seen from Embodiment 1-1 and Embodiments 2-11 to 2-14, when the thickness h₁ of the first base film and the thickness h₂ of the second base film fall within the range specified herein, the adhesion F₁ of the first separator to the negative electrode plate, the adhesion F₂ of the second separator to the positive electrode plate, and the adhesion F₃ of the second separator to the negative electrode plate are relatively large. The thickness of the lithium-ion battery is relatively small, indicating that the energy density of the lithium-ion battery with the same volume is relatively high. In addition, the capacity retention rate and the 130° C. and 135° C. hot-oven test pass rate of the lithium-ion battery are relatively high. The lithium-ion battery of this application exhibits a relatively long cycle life and superior high-temperature thermal abuse performance while achieving a desirable energy density. In Embodiment 2-13, the thicknesses of the first base film and the second base film are relatively small. Therefore, the first ceramic particles and/or the second ceramic particles are more prone to pierce the separator and cause a short circuit in the hot-oven test, thereby exhibiting lower high-temperature thermal abuse performance. In Embodiment 2-14, the thicknesses of the first base film and the second base film are relatively large. Therefore, the thickness of the lithium-ion battery is relatively large, thereby causing a slight loss to the energy density.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A secondary battery, comprising an electrode assembly, wherein the electrode assembly is a jelly-roll structure; the electrode assembly comprises a positive electrode plate, a negative electrode plate, a first separator, and a second separator;
the first separator comprises a first base film, a first adhesive layer, and a first ceramic coating; the first ceramic coating is located between the first base film and the first adhesive layer; the first base film is a nonwoven fabric film; the first adhesive layer comprises a first binder; the first binder comprises at least one of polyvinylidene fluoride or poly(vinylidene fluoride-co-hexafluoropropylene); the first ceramic coating comprises first ceramic particles; and the first ceramic particles comprise at least one of aluminum oxide, zirconium dioxide, titanium dioxide, or silicon dioxide; and
the second separator comprises a second base film, a second adhesive layer, and a second ceramic coating; the second ceramic coating is located between the second base film and the second adhesive layer; the second base film is a polymeric microporous film; the second adhesive layer comprises a second binder; the second binder comprises at least one of polyimide, polyvinyl alcohol, or sodium carboxymethyl cellulose; the second ceramic coating comprises second ceramic particles; and the second ceramic particles comprise bochmite.

2. The secondary battery according to claim 1, wherein the negative electrode plate is located between the first separator and the second separator; the negative electrode plate comprises a negative current collector, a first negative electrode material layer, and a second negative electrode material layer; the first negative electrode material layer and the second negative electrode material layer are located on two sides of the negative current collector respectively; and, along a winding direction of the electrode assembly, a length of the first negative electrode material layer is greater than a length of the second negative electrode material layer, the first separator and the first negative electrode material layer are located on a first side of the negative electrode plate, and the second separator and the second negative electrode material layer are located on a second side of the negative electrode plate.

3. The secondary battery according to claim 2, wherein the second separator is located between the positive electrode plate and the negative electrode plate, the first ceramic coating is located on both sides of the first base film, the first ceramic particles comprise aluminum oxide, and the second ceramic coating is located on only one side of the second base film facing away from the negative electrode plate.

4. The secondary battery according to claim 1, wherein an average particle diameter of the first ceramic particles is 0.2 μm to 1.2 μm, and an average particle diameter of the second ceramic particles is 0.1 μm to 1.0 μm.

5. The secondary battery according to claim 4, wherein a thickness of the first ceramic coating is 0.5 μm to 1.5 μm, and a thickness of the second ceramic coating is 0.3 μm to 1.5 μm.

6. The secondary battery according to claim 1, wherein a thickness of the first base film is 10 μm to 15 μm, and a thickness of the second base film is 3 μm to 9 μm.

7. The secondary battery according to claim 1, wherein an average pore diameter of the first base film is 80 nm to 700 nm, and an average pore diameter of the second base film is 50 nm to 200 nm.

8. The secondary battery according to claim 1, wherein the first base film comprises polyethylene terephthalate, and the second base film comprises at least one of polypropylene or polyethylene.

9. The secondary battery according to claim 8, wherein a glass transition temperature of the first base film is 80° C. to 100° C., and a glass transition temperature of the second base film is 25° C. to 50° C.

10. The secondary battery according to claim 2, wherein an average particle diameter of the first ceramic particles is 0.2 μm to 1.2 μm, and an average particle diameter of the second ceramic particles is 0.1 μm to 1.0 μm.

11. An electronic device, comprising the secondary battery according to claim 1.

12. The electronic device according to claim 11, wherein the negative electrode plate is located between the first separator and the second separator; the negative electrode plate comprises a negative current collector, a first negative electrode material layer, and a second negative electrode material layer; the first negative electrode material layer and the second negative electrode material layer are located on two sides of the negative current collector respectively; and, along a winding direction of the electrode assembly, a length of the first negative electrode material layer is greater than a length of the second negative electrode material layer, the first separator and the first negative electrode material layer are located on a first side of the negative electrode plate, and the second separator and the second negative electrode material layer are located on a second side of the negative electrode plate.

13. The electronic device according to claim 12, wherein the second separator is located between the positive electrode plate and the negative electrode plate, the first ceramic coating is located on both sides of the first base film, the first ceramic particles comprise aluminum oxide, and the second ceramic coating is located on only one side of the second base film facing away from the negative electrode plate.

14. The electronic device according to claim 11, wherein an average particle diameter of the first ceramic particles is 0.2 μm to 1.2 μm, and an average particle diameter of the second ceramic particles is 0.1 μm to 1.0 μm.

15. The electronic device according to claim 14, wherein a thickness of the first ceramic coating is 0.5 μm to 1.5 μm, and a thickness of the second ceramic coating is 0.3 μm to 1.5 μm.

16. The electronic device according to claim 11, wherein a thickness of the first base film is 10 μm to 15 μm, and a thickness of the second base film is 3 μm to 9 μm.

17. The electronic device according to claim 11, wherein an average pore diameter of the first base film is 80 nm to 700 nm, and an average pore diameter of the second base film is 50 nm to 200 nm.

18. The electronic device according to claim 11, wherein the first base film comprises polyethylene terephthalate, and the second base film comprises at least one of polypropylene or polyethylene.

19. The electronic device according to claim 18, wherein a glass transition temperature of the first base film is 80° C. to 100° C., and a glass transition temperature of the second base film is 25° C. to 50° C.

20. The electronic device according to claim 12, wherein an average particle diameter of the first ceramic particles is 0.2 μm to 1.2 μm, and an average particle diameter of the second ceramic particles is 0.1 μm to 1.0 μm.
